(19) United States
(12) Patent Application Publication
(10) Pub. No.: US 2008/0319807 A1
(43) Pub. Date: Dec. 25, 2008

(54) Management of Room Cleaning

(75) Inventor: Soenke Weiss, Wakerley (AU)

Correspondence Address: DENNISON, SCHULTZ & MACDONALD, 1727 KING STREET, SUITE 105, ALEXANDRIA, VA, 22314, US

(73) Assignee: SLAP HOLDINGS PTY LTD, Holland Park West (AU)

(21) Appl. No.: 12/095,976

(22) PCT Filed: Jan. 31, 2007
(86) PCT No.: PCT/AU07/00099

§ 371 Date: Jun. 3, 2008

(30) Foreign Application Priority Data
Feb. 1, 2006 (AU) 2006900468
Feb. 1, 2006 (US) 60763924

(51) Int. Cl. G06Q 10/00; G06Q 50/00

(52) U.S. Cl. 705/5; 705/8; 705/9

(57) ABSTRACT

Systems for management of room cleaning at an accommodation facility such as a hotel. The system records variables related to the occupancy of rooms at the facility and/or operational characteristics of the facility. Daily cleaning times are determined for rooms in accord with the variables. Daily cleaning plans are then determined for the facility in accord with the cleaning times. Cleaning staff carry out the plan and report their progress using conventional means such as the local telephone system or wireless PDAs.

### BACKGROUND TO THE INVENTION

This invention relates to methods for managing the housekeeping of rooms in accommodation facilities such as hotels, hostels and motels, and in particular to a method for planning the times required to clean a large number of rooms with differing occupants.

The housekeeping department of a hotel is responsible for cleaning of guest rooms and other areas of the hotel premises, and can account for as much as 70% of the overall staffing requirements. Managing the cleaning workforce on a daily basis to cover a large number of rooms is important for control of the running cost and quality of the guest experience at a hotel. Inefficient processes usually result in unnecessarily high labour costs and lost opportunities for quality of service.

A number of relatively simple computer systems are available for management of room cleaning in hotels. These systems usually involve a calculation based on fixed cleaning times according to room type, and whether an interim or full cleaning process is required. Some systems apply a global multiplication factor according to further conditions such as weekends. However, the times estimated using these systems can vary greatly from the times actually required by the available staff, due to the effects of occupancy and other variables.

### SUMMARY OF THE INVENTION

It is an object of the invention to provide for improved management of room cleaning at hotels and similar facilities, or at least to provide an alternative to existing management processes.

In one aspect the invention may be said to reside in a method of managing the cleaning of rooms at an accommodation facility such as a hotel, including: recording variables related to the occupancy of rooms at the facility and/or operational characteristics of the facility, determining cleaning times for rooms in accord with the variables, and determining cleaning plans for the facility in accord with the cleaning times.

Preferably the variables related to occupancy of the rooms include room type and one or more of: number of adults occupying the room, number of children occupying the room, length of occupancy of room, reason for occupancy of room. Preferably the variables related to operational characteristics of the facility include one or more of: experience of the cleaning staff, predetermined cleaning tasks for the room, time of travel between rooms, availability of resources at the facility and other requirements of the facility.

Each of the variables is associated with a predetermined cleaning interval or predetermined cleaning factor, and an overall cleaning time is determined for each room by adding intervals and multiplying by factors according to the variables relevant to the respective room. In general, the variables relating to occupancy of the rooms are recorded at the time of booking and/or check-in by the occupants.

Preferably the step of determining daily cleaning plans includes selecting a sequence of rooms to be cleaned in accord with one or more further variables including: travel times between the rooms, departure time of current occupants, arrival time of new occupants, staff schedules and availability of consumables for rooms.

Preferably the method further includes monitoring the actual cleaning time for each room and modifying the relevant variables, or checking with relevant staff, as required.

In another aspect the invention resides in a computer system for management of cleaning services at an accommodation facility, including: a database for recording variables related to the occupancy of rooms at the facility and/or operational characteristics of the facility, a component which determines daily cleaning times for rooms in accord with the variables, and a component which determines daily cleaning plans for the facility in accord with the cleaning times.

Preferably the system includes a wireless communication subsystem having a plurality of mobile computers used by cleaning staff according to respective cleaning plans.

The invention further resides in any alternative combination of features that indicated in this specification. All equivalents of these features are deemed to be included whether or not explicitly mentioned.

### LIST OF FIGURES

Preferred embodiments of the invention will be described with respect to the accompanying drawings, of which:

FIG. 1 outlines an overall system for management of room cleaning,

FIG. 2 schematically shows operation of the system at an accommodation facility,

FIG. 3 outlines the flow of a process for determining a cleaning schedule,

FIG. 4 outlines a calculation of individual room cleaning times,

FIG. 5 outlines a process for optimising a cleaning schedule,

FIG. 6 shows a computer interface indicating definition of variables,

FIG. 7 shows a computer interface indicating staffing requirements,

FIG. 8 shows a computer interface indicating progress on a cleaning schedule,

FIG. 9 provides two examples of cleaning time calculations,

FIG. 10 shows components of a computer program for implementing the system, and

FIG. 11 shows the interface of a typical PDA used by cleaning staff.

### DESCRIPTION OF PREFERRED EMBODIMENTS

Referring to the drawings it will be appreciated that the invention may be implemented in a range of different ways and for a range of different accommodation facilities. The embodiments described here are given by way of example only.

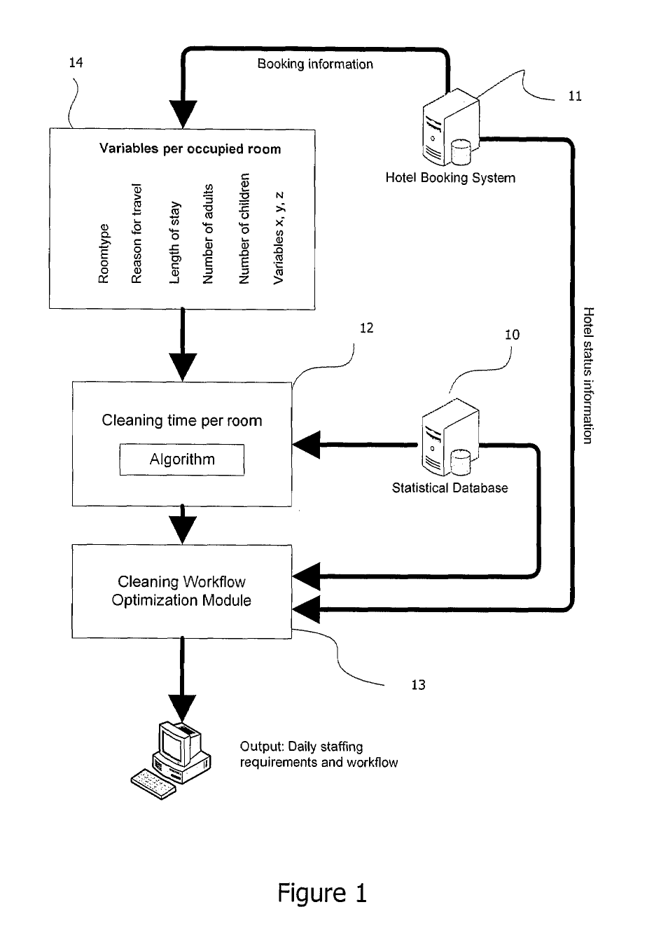

FIG. 1 shows a computer based system for determining room cleaning times in an accommodation facility such as a hotel, and for determining a cleaning plan for staff at the facility. A central server and database 10 contains a set of variables which affect the overall cleaning time for each room. A database 11 is part of the hotel booking system and records information relating to the current and expected occupants of the hotel. Each day the cleaning system analyses the data contained in the booking database 11 using an algorithm 12, and determines an expected cleaning time for each room, according to the variables 14 which are applicable to that room. A planing module 13 then determines a schedule for the staff who clean the rooms and will also generally make use of different variables to determine the overall time required and to optimise the allocation of staff to different rooms.

A wide range of variables may be used in FIG. 1 to determine the cleaning time for each room. The most important variables typically relate to occupancy of the rooms, and include room type, number of adults occupying the room, number of children occupying the room, length of occupancy of room, reason for occupancy of room. The room type may be considered as a baseline to which other variables are added, subtracted or factored to determine a practical cleaning time. Other variables related to operational characteristics of the facility may also be used, including one or more of: experience of the cleaning staff, predetermined cleaning tasks for the room, time of travel between rooms, availability of resources at the facility. Each of the variables is associated with a predetermined cleaning interval or predetermined cleaning factor, and an overall cleaning time is determined for each room by adding intervals and multiplying by factors according to the variables relevant to the respective room.

A wide range of variables related to occupancy of rooms and operational characteristics of the facility may be specified in practice, and the operators of a particular facility are able to tailor the system to suit their circumstances. Variables considered to be potentially significant at present include:
1. Type of clean, eg. Departure, stay-over
2. Room type
3. Reason for travel
4. Length of stay
5. Number of adult occupants
6. Number of child occupants
7. Gender of guests, if available
8. Day of week
9. Special periods, eg. Sporting events, school holidays, etc
10. Number of housekeepers assigned to a room
11. Experience level of housekeeper
12. Special recurring cleaning tasks
13. Required trolley restock
14. Travelling times between rooms/lunch room/office/linen stores
15. Special requests of arriving guests

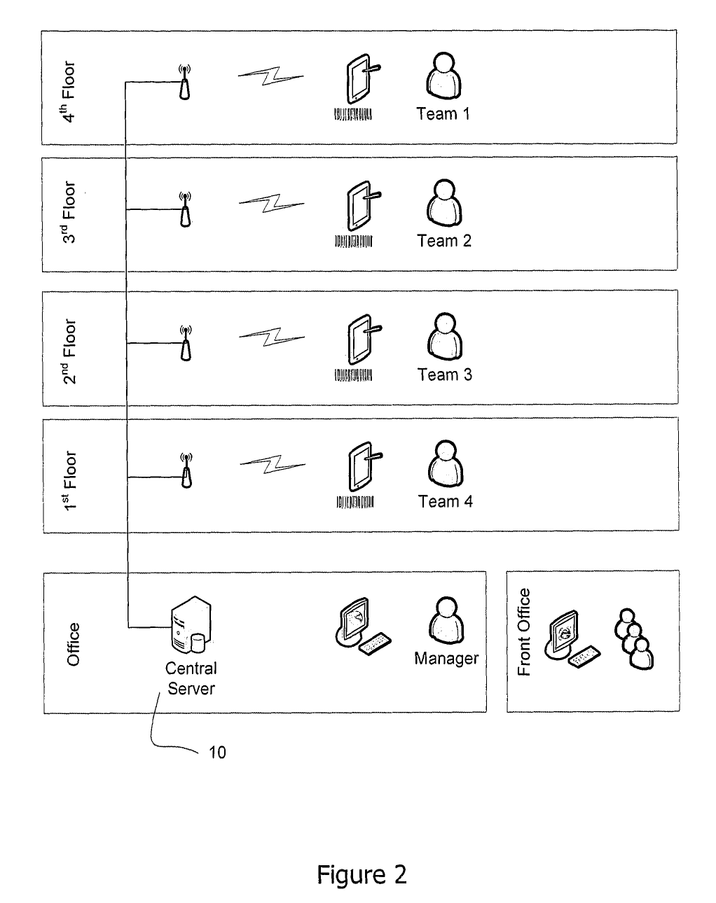

FIG. 2 schematically shows how a daily cleaning plan may be implemented in a typical accommodation facility. In this example the facility includes rooms spread over four floors in a building. Teams 1-4 are allocated cleaning duties on respective floors. A manager operates the central server 10 from an administration office and communicates with each team using a wireless system and mobile computers such as personal digital assistants (PDAs). A PDA is typically attached to each cleaning trolley to provide an up to date indication of the duties required for each room. Staff in a particular team determine their duties from the PDA and respond by entering the progress of their work in each room. Alternatively the teams may simply communicate with the manager using the standard telephone services which are provided in each room. The central server also receives booking and/or check-in data from a front office computer.

The central server 10 in FIGS. 1 and 2 is implemented in a conventional fashion, typically using a desktop computer. The computer includes a microprocessor, memory, screen, keyboard, printer and other standard features. A wireless hub may also be provided for communication with the PDAs. The software which carries out the cleaning time calculations, optimisation and other processes is typically loaded unto the computer from a separate storage medium such as a portable disc.

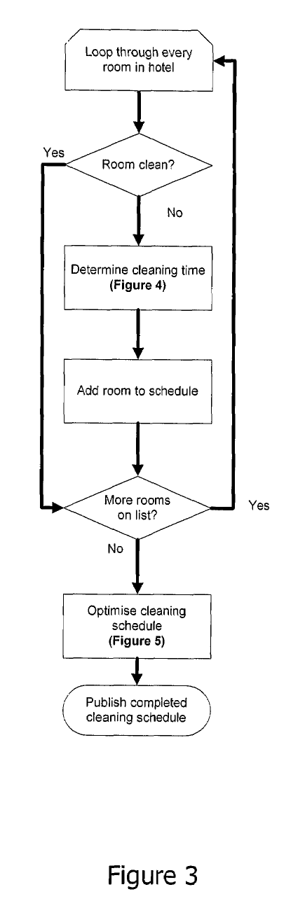

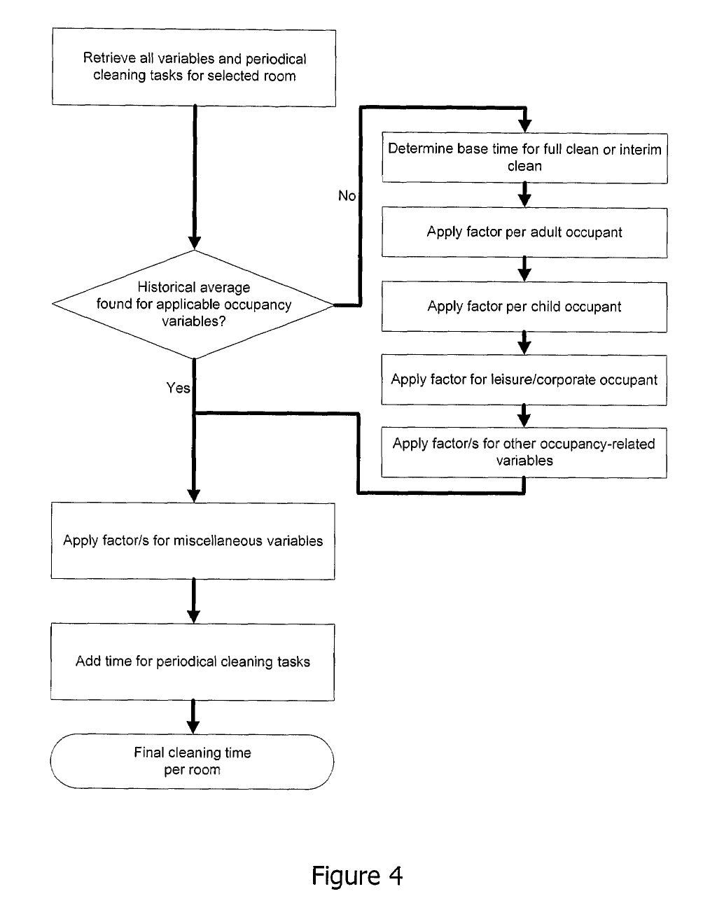

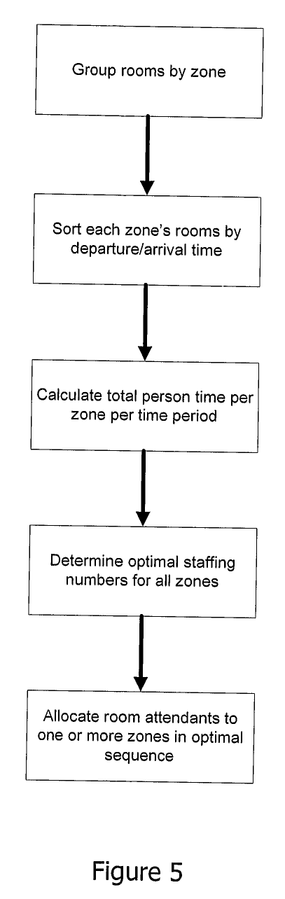

FIG. 3 outlines a process for determining an overall cleaning time and a schedule for the facility, giving more detail than FIG. 1. The process loops through every room in the hotel, and determines the cleaning requirements of each room. Some rooms do not require cleaning and are ignored. For rooms requiring cleaning, their expected time is calculated using variables appropriate to the occupancy of the room, as shown in FIG. 4, and they are added to the daily cleaning schedule. The schedule is then optimised, as shown in FIG. 5, and output for use by the staff.

FIG. 4 provides more detail of the calculation process for each room in a facility. The process creates a schedule containing data for each room which requires cleaning. All variables and periodical tasks which may be relevant to a particular room are retrieved from the database. If an historical average cleaning time exists for the occupancy variables relating to the room, then the average may be used in calculating the time required. Otherwise the process calculates a cleaning time using specific variables related to the occupancy. Factors may then be applied for miscellaneous variables, such as day of the week, and further time added for periodical tasks, such as turning the mattress. A final time for cleaning of the room may then be output.

FIG. 5 shows how a cleaning schedule may be optimised once the time required for each room has been determined. The rooms are first grouped by zone, such as all rooms on a particular floor or in a particular wing of the facility. The rooms are then sorted into zone sequences according to departure and arrival times of the current and expected occupants. Rooms for which the occupants are remaining the same are generally allocated to fill time between other rooms in the sequences. Optimal staffing numbers are then determined for the zones, and staff are allocated to a particular zone and sequence.

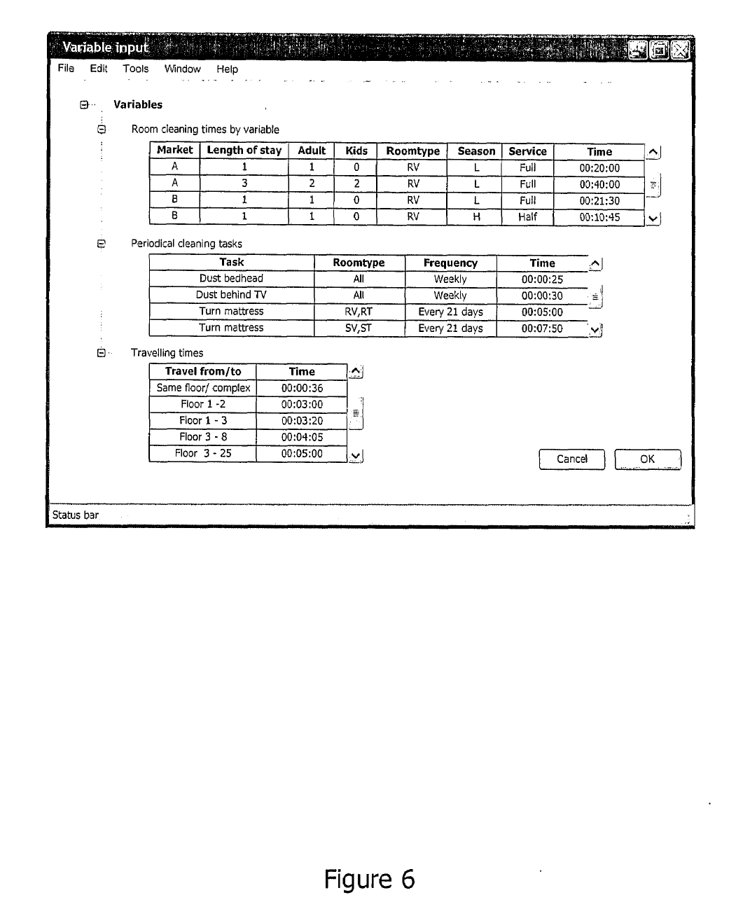

FIG. 6 shows a user interface illustrating how variables are stored in the database 10 of FIG. 1. Three types of variable are indicated, namely occupancy variables, periodical tasks and travel times between rooms. The definition of each variable includes a time interval which is added into the calculations outlined above when determining an overall cleaning time. The first occupancy variable indicates an interval of 20 minutes for full service of a room of type RV, occupied by one adult for one day during the low season, for example. The first periodical variable indicates an interval of 25 seconds for dusting the bedhead for any room type, required on a weekly basis. The first travel variable indicates a time of 36 seconds required for staff moving between floors 1 and 2 of the particular facility. These variables can be edited manually, or updated automatically, when actual times are recorded by staff.

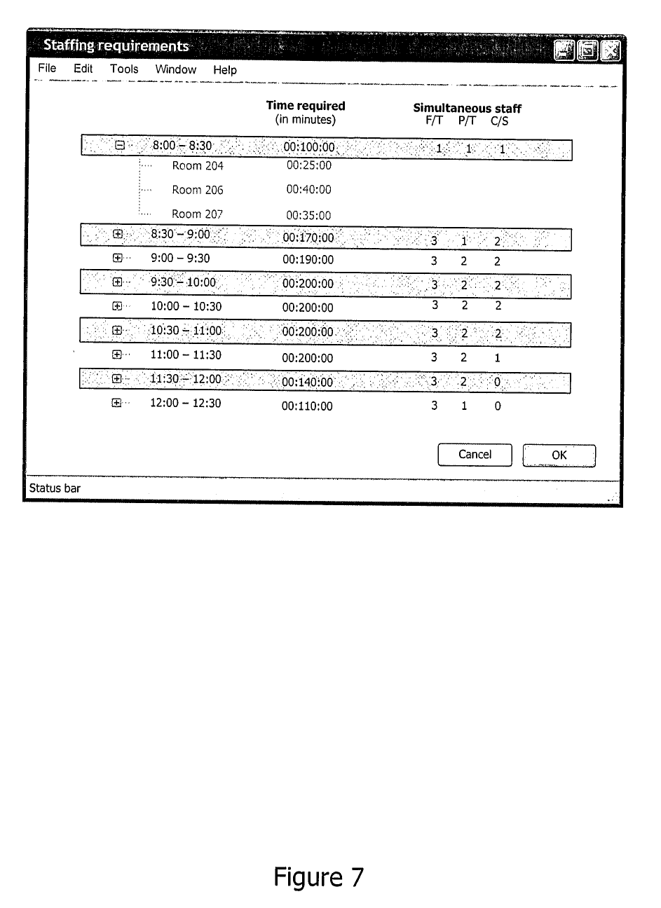

FIG. 7 shows a user interface illustrating the overall cleaning times calculated for a facility on a particular day. The morning is divided into half hourly periods and rooms have been scheduled for cleaning in those periods. The total cleaning time for each period has been determined and the corresponding numbers of staff have been allocated. The first cleaning period from 8 to 8.30 am involves a total of 100 minutes cleaning time for rooms 204, 206, 207, for example, and three staff are required.

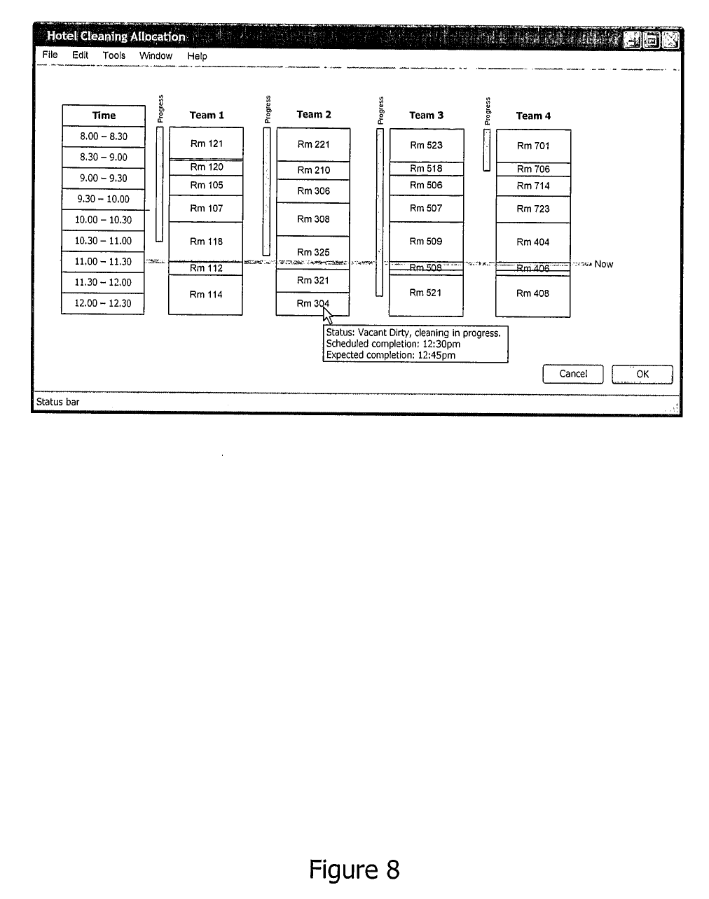

FIG. 8 shows a user interface illustrating how room cleaning progress may be monitored during the day by a manager. The cleaning staff have been divided into four teams, each with a sequence of rooms to cover, as shown in FIG. 1 for example. Each sequence is represented as a vertical bar which is divided into room portions according to the calculated cleaning times. Progress is typically reported by the team using a wireless unit such as a PDA but may also be reported manually, A progress bar is placed beside each sequence bar to indicate the current location of the respective team in relation to their expected location. Team 2 for example, are currently working on room 325 and are progressing as expected, while Team 4 are well behind. A rollover function provides data on each room if required.

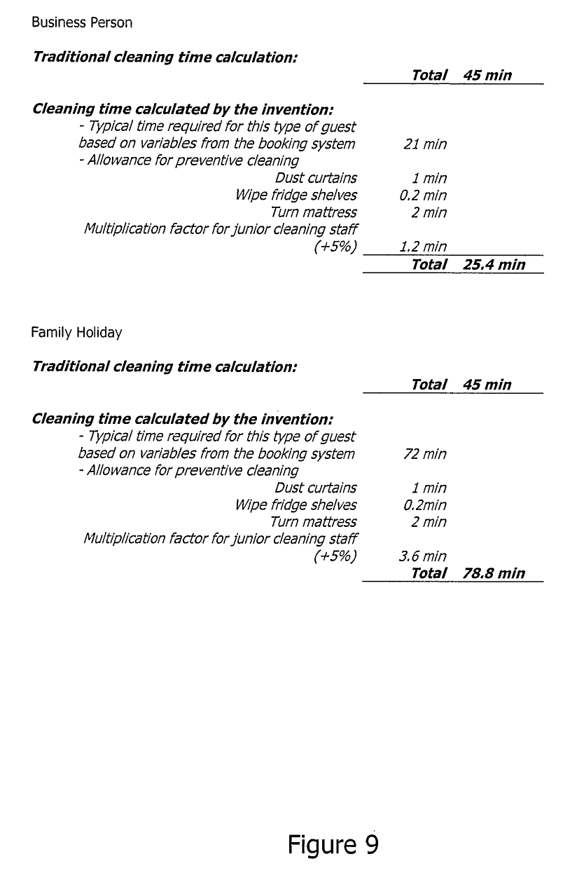

FIG. 9 illustrates two scenarios encountered during a typical day in a hotel and contrast traditional cleaning time against more accurate times calculated by the system above. Both scenarios involve the same room, with different occupants, scheduled for a full clean after departure on a Wednesday. The traditional cleaning time is indicated as 45 minutes in each case. In the “business person” scenario, a middle-aged male visits a central Sydney hotel to attend a conference. He stays for one night only, attending a conference all day, followed by a dinner with colleagues. This guest uses the bed and shower only and checks out on a Wednesday. The calculated cleaning time is about 26 minutes. In the “family holiday” scenario, a family of 2 adults and 2 young children visits the same hotel and stays in the same room. They stay for 3 nights (checking out on a Wednesday) and frequently return to the room during the day, making extensive use of all facilities. Cleaning staff need to pay full attention to this room, including special care to the carpet. The calculated cleaning time is about 79 minutes. It can be seen that the calculated times are significantly different from the traditional times in each case. Depending on fluctuations in occupancy at the hotel, the overall cleaning time required for particular floor could be substantially less than or greater than traditionally expected.

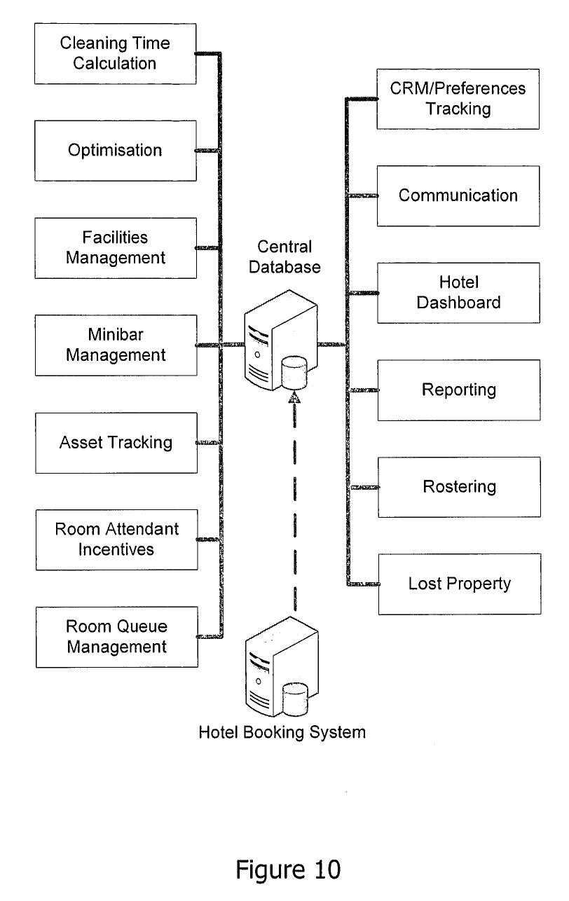

FIG. 10 shows typical software modules or components for the computer system indicated in FIG. 1. The function of most of these components is self explanatory or has already been mentioned. A summary of the functions is included below.

| | |
|---|---|
| Cleaning time | Calculates the forecasted cleaning time per room |
| (item 12 in FIG. 1) | based on relevant variables |
| Optimisation | Determines the optimal workflow sequence in |
| (item 13 in FIG. 1) | cleaning rooms |
| Facilities | Facilitates the tasks performed by a hotel's |
| Management | maintenance department, including energy |
| | management |
| Minibar | Facilitates the recording of guest consumption of |
| Management | Minibar items and stock control |
| Asset Tracking | Enables the recording of a hotel's fixed assets and |
| | their movements using a barcode reader |
| Room attendant | Management of employee performance in a |
| incentives | performance-based housekeeping department |
| Room Queue | Managing the allocation of available rooms to |
| Management | arriving guests before the rooms have been cleaned |
| CRM/Preferences | Recording guest preferences and alerting the |
| Tracking | cleaners with a view to catering for special |
| | requirements before a guest's arrival |
| Communication | Facilitating communication between hotel staff |
| | across departments by providing audited |
| | communication paths |
| Hotel Dashboard | A central view of the hotel's current status from an |
| | occupancy and housekeeping perspective |
| Reporting | A module providing flexible reporting options that |
| | address numerous requirements of a housekeeping |
| | department |
| Rostering | A module that enables the conversion of the |
| | optimised workflow into a roster of available hotel |
| | staff with a potential interface to a payroll system |
| Lost Property | Recording items left behind by guests including |
| | automatic alerts to the guests and providing an |
| | audited path of unclaimed items. |

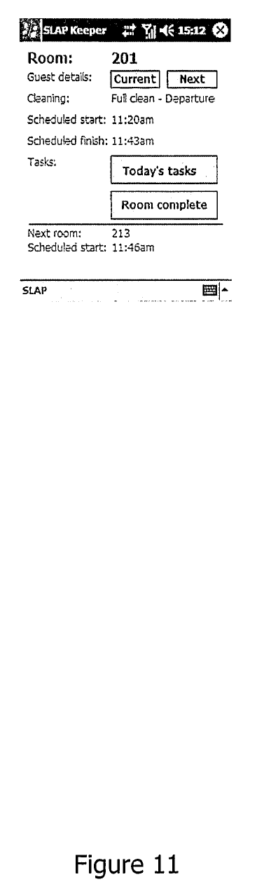

FIG. 11 shows the layout of a typical PDA interface, typically a touchscreen, in the wireless communication system of FIG. 2. In this example the interface indicates that the team is currently working on Room 201, carrying out a full clean after departure. The expected time of the cleaning operation is 23 minutes with a further 3 minutes allowed to commence the next job in Room 213. A full list of tasks required for the current room is available on touching the appropriate key. A further key is provided for a staff member to indicate when work on the room is complete.

It will be appreciated that systems according to the invention can enable greater efficiency in the housekeeping services at a hotel or similar facility. Cleaning times may be calculated on a logical basis and used to schedule the function of staff throughout the day.

1. A method of managing the cleaning of rooms at an accommodation facility such as a hotel, including:
recording variables related to the occupancy of rooms at the facility and/or operational characteristics of the facility,
determining cleaning times for rooms in accord with the variables, and
determining cleaning plans for the facility in accord with the cleaning times.

2. A method according to claim 1 wherein the variables related to occupancy of the rooms include room type and one or more of: number of adults occupying the room, number of children occupying the room, length of occupancy of room, reason for occupancy of room, or other characteristics of occupancy.

3. A method according to claim 1 wherein the variables related to operational characteristics of the facility include one or more of: experience of the cleaning staff, predetermined cleaning tasks for the room, time of travel between rooms, availability of resources at the facility, or other requirements of the facility.

4. A method according to claim 1 wherein each of the variables is associated with a predetermined cleaning interval or predetermined cleaning factor, and an overall cleaning time is determined for each room by adding intervals and multiplying by factors according to the variables relevant to the respective room.

5. A method according to claim 1 wherein the step of determining daily cleaning plans includes selecting a sequence of rooms to be cleaned in accord with one or more further variables including: travel times between the rooms, departure time of current occupants, arrival time of new occupants, staff schedules and availability of consumables for rooms.

6. A method according to claim 1 further including monitoring the actual cleaning time for each room and modifying the corresponding variables, or checking with relevant staff, as required.

7. A method according to claim 1 further including:
transmitting the cleaning plans to mobile computers for use by cleaning staff, and
receiving acknowledgements from the staff on completion of respective portions of the cleaning plans.

8. A method according to claim 1 wherein the cleaning plans are determined on a daily basis and divided among teams of cleaning staff according to the layout of the facility.

9. A method according to claim 1 wherein the variables relating to occupancy of the rooms are recorded at the time of booking and/or check-in by the occupants.

10. A computer system for management of cleaning services at an accommodation facility, including:
a database for recording variables related to the occupancy of rooms at the facility and/or operational characteristics of the facility,
a component which determines daily cleaning times for rooms in accord with the variables, and
a component which determines daily cleaning plans for the facility in accord with the cleaning times.

11. A system according to claim 10 wherein the variables related to occupancy of the rooms include room type and one or more of: number of adults occupying the room, number of children occupying the room, length of occupancy of room, reason for occupancy of room.

12. A system according to claim 10 wherein the variables related to operational characteristics of the facility include one or more of: experience of the cleaning staff, predetermined cleaning tasks for the room, time of travel between rooms, availability of resources at the facility and other requirements of the facility.

13. A method according to claim 10 wherein each of the variables is associated with a predetermined cleaning interval or predetermined cleaning factor, and an overall cleaning time is determined for each room by adding intervals and multiplying by factors according to the variables relevant to the respective room.

14. A system according to claim 10 further including:
a wireless communication subsystem having a plurality of mobile computers used by cleaning staff according to respective cleaning plans.

15. A computer storage medium containing program instructions for carrying out the method of any of claim 1.
